(19) United States
(12) Patent Application Publication
(10) Pub. No.: US 2003/0014285 A1
(43) Pub. Date: Jan. 16, 2003

(54) No pay annuity method

(76) Inventor: Daniel D. Richard, North Ocean Ridge, FL (US)

Correspondence Address: R. Neil Sudol, COLEMAN SUDOL SAPONE, P.C., 714 Colorado Avenue, Bridgeport, CT, 06605-1601, US

(21) Appl. No.: 10/134,055

(22) Filed: Apr. 25, 2002

Related U.S. Application Data
(60) Provisional application No. 60/287,146, filed on Apr. 27, 2001.
(60) Provisional application No. 60/332,316, filed on Nov. 16, 2001.

(51) Int. Cl. G06F 17/60

(52) U.S. Cl. 705/4

(57) ABSTRACT

In an insurance and/or annuity method, stem cells or other biological material of an individual are stored as a primary or ancillary part of an insurance policy. Fees are collected by an insurance company for the preservation of umbilical cord blood cells including stem cells, peripheral blood cells or other biological material of the policy holder, a secondary insured, or a beneficiary. The preservation and storage company is paid periodically for continuing storage costs either from an insurance policy premium or from the cash value of the insurance policy or directly by the policy holder or other interested party.

### CROSS-REFERENCE TO RELATED APPLICATIONS

This application claims the benefit of U.S. Provisional Patent Application No. 60/287,146 filed Apr. 27, 2001 and U.S. Provisional Patent Application No. 60/332,316 filed Nov. 16, 2001, the disclosures of which are hereby incorporated by reference.

### FIELD OF THE INVENTION

This invention relates to a business method utilizable in the insurance industry. More particularly, the present invention relates to a method for use in funding the preservation and storage of biological materials such as adult and neonatal stem cells.

### BACKGROUND OF THE INVENTION

To date in the United States, insurance companies have looked at cord blood preservation as experimental and therefore have not agreed to pay for this procedure for over 99% of the 4,000,000 babies born this country each year. They have provided full coverage including annual storage fees for newborns with a family history of cancer, leukemia or other genetically or if predisposed to certain diseases. This policy has remained in effect in the United States despite the fact that the New England Journal of Medicine has cited the advantages of using cord blood versus bone marrow for transplantation. In the past, insurance company actuaries did not feel it cost-effective to provide this as an ancillary service to a life insurance or other policy because of what life insurance companies perceive is limited usage for preserved cord blood stem cells and other cells from individual policy holders. This short-sighted approach has been myopic in not taking into consideration the evolving medical technology, which has greatly expanded the use of cord blood stem cells to treat a variety of diseases or to use stem cells for the creation of organs, such as heart, lungs, liver, bone, eyes, including corneas, repairing nervous system tissue including the brain and spinal cord, reconstituting blood (hematopoiesis) and numerous other medical procedures. In addition, the cells, including stem and/or peripheral cells may provide numerous other advantages in providing therapeutic uses and otherwise expanding the quality of life or extending the life of a policy holder.

In the United States alone, more than 4,000,000 babies are born each year, most of which do not have their umbilical cord blood stored. Despite the large numbers and tremendous opportunity this represents, however, there is only about a 72 hour window after birth of a baby in which a decision must be made to cryopreserve cord blood from that baby. In the case of storage of peripheral blood material and other tissue, including biological material such as DNA, the timing of such storage is not as critical as it is in the case of an infant. Thus, there is a tremendous need and opportunity to provide services for individuals, whatever the age of the policy holder.

### SUMMARY OF THE INVENTION

The present invention is directed in principal part to solving the problem of funding the preservation and storage of biological materials such as stem cells, DNA, umbilical cord blood, etc., with the long-term view of eventually possibly releasing the preserved and stored biological materials for use in medical procedures to enhance and extend people's lives. Pursuant to one embodiment of the invention, the funds for the initial services in the preservation and storage process, namely, for collecting, testing and processing the biological materials are provided by an insurance company as part of the cost of attracting new policy holders or extending insurance protection to existing policy holders. More specifically, these initialization funds for start-up costs may be part of the overhead of the insurance company. Alternatively, the funds may be freed from the requisite on-hand cash reserves of the insurance company owing to a diminution of the cash value of the policies pursuant to agreement with the policy holders. In any event, the insurance company reimburses a preservation and storage company for the initial costs involved in processing and preserving biological materials for the insurance company's policy holders. Subsequently, the annual fees for continuing the preservation and storage of the biological materials are preferably paid by the policy holder or other interested party directly to the preservation and storage company (or a successor in interest). That company may have an agreement with the insurance company, whereby the annual storage fees are split with the insurance provider, partially or fully reimbursing the insurance company for covering the initial costs. Where there is a splitting or sharing of the annual fee payments made by the policy holder, a secondary insured, a beneficiary or other person, the respective percentages may vary in any way suitable to the purposes of the two companies.

In an alternative procedure, the annual fees for continuing the preservation and storage of the biological materials may be paid out of insurance premiums or by the insurance company in return for reduced cash values of the applicable insurance policies. Some of these continuing costs may be borne by the storage and preservation company in return for the insurance company's partnering on the initial costs.

In an alternative or supplementary embodiment of the present invention, kits (e.g., catheters, needles, storage pouches, forms, etc.) for the collection of biological materials may be given to the policy holders by the insurance company. Providing the collection kits to the policy holders serves to build interest in the preservation program and facilitates the recruitment and initialization process.

Pursuant to another feature of the present invention, the insurance company may permit policy holders to gift a preservation right to another party. Pursuant to this gifting feature, biological materials which are preserved and stored are derived not from the policy holder or a member of the policy holder's family but from the third party or a member of the third party's family. This gifting potential is useful in cases, for instance, where a policy holder does not wish to have children and knows someone who is pregnant or apt to have a child.

The preservation and storage of biological materials such as stem cells, umbilical cord or placental blood, DNA, etc., may be financially supported by other methods, for instance, as a periodic charge (e.g., one dollar a month per employee) included in premiums for all employees of a company. The charge may be so little because for many industries, the percentage of employees who become pregnant over any given time period is fairly low.

The present invention is directed principally to an insurance and/or annuity method in which stem cells or other biological material of an individual are stored and preserved as a primary or ancillary part of an insurance policy. The method provides for the collection, by an insurance company, of fees for the preservation of umbilical cord blood cells including stem cells, peripheral blood cells or other biological material of the policy holder, a secondary insured, or a beneficiary. In one embodiment of the invention, the insurance company collects a fee from the policy holder as part of an insurance policy premium. The premium fees are typically used to pay all or part of continuing storage costs. These premium fees may also be used to pay for all or part of the initialization fees for collecting, testing, and processing the biological material. In an alternative embodiment, the initial processing and preservation fees and/or the continuing storage fees are charged against the cash value of the insurance policy. In that case, the insurance company need not maintain as much cash in reserve, thereby enabling investment or expenditure of the unneeded reserves.

The present invention provides a method for facilitating the preservation of life-extending biological materials such as stem cells. The well-established methods and apparatus of the insurance industry provide a vehicle for financially supporting and thereby promoting and advancing the preservation and storage process. Moreover, the benefit could come at no cost to the insurance industry. To the contrary, an insurance company is provided either with additional cash infusion, should the insurance company retain a portion of fees paid by policy holders for the storage process, or with an additional marketing tool to promote the company's other insurance products. Other possible benefits to the insurance company are described hereinafter.

The present invention is directed to a no pay annuity as an insurance method. The invention contemplates offering alone or as a service ancillary to a life insurance or other insurance policy (for example, a health insurance policy, disability insurance policy, etc.), the long-term storage and preservation of cellular or other biological material (whether tissue based, cellular or molecular, including DNA and polypeptide) of a policy holder, a secondary insured or a third party beneficiary for a fixed annual fee. Under the present method, the preparation of the biological material for storage is performed under standard procedures (generally, cryopreservation) well known in the art and is paid for by the insurance company. The actual cost of the preparation in the present method is often less than the cost to the insurance company of obtaining new policy holders.

After collection, testing and processing of biological material, the cost of these initial preservation steps being preferably covered by the insurance company (either through general cost savings or from the cost of the policy), the policy holder will pay a periodic, e.g., annual, fee to continue the storage and preservation of the biological material. The periodic fee may be drawn from an insurance policy premium or from the cash value of a policy or may be paid directly to the preservation and storage company by the policy holder. The cost of the annuity will preferably be a reasonable cost in order to induce the policy holder to continue to pay the annuity. For example, a fee of $50-100 per year would provide an acceptable margin for the insurance company. The fee may be used by the insurance company to pay for preservation and storage of the biological material by a third party, or alternatively, the insurance company may joint venture or split the fee with the storage provider. In either case, a non-financial services company is paid by the insurance company for the performance of non-financial services.

The value of the annuity to the insurance company is greater than the value of other annuities which must be paid upon the occurrence of certain events, in many instances, death, because the insurance company, while collecting an annuity fee for the storage and maintenance of the biological material, will have little or no cost generation which occurs at the point when the policy holder exercises or “collects” on the policy. This is because the exercise or “collection” of the policy manifests itself in the release of the biological material, typically to enable the execution of therapeutic processes. The use of such material is rare and generally occurs only in the event of a life threatening illness or other unusual event. Moreover, the retrieval and release of the biological material is at zero cost to the companies involved. Generally, the costs of retrieval and delivery of the biological materials for medical or other use are borne by the policy holder or another person related by blood or familial ties to the individual from whom the stored materials were obtained. Thus, the relatively rare instance in which the biological material is to be used, coupled with the relative lack of expense in releasing the biological material for a biological process or therapeutic procedure, makes the annuity method of the present invention a no pay method, a business approach which is heretofore nonexistent in the insurance industry.

Another advantage of the present invention is that biological material, in particular, stem cells such as stems cells from a neonate are becoming increasingly valuable for research purposes as well as other procedures in allogeneic patients (cells, etc., from another person). Thus, in certain instances after the individual policy holder dies, an agreement can be made with the individual policy holder or other family member to allow ownership of the biological material to be transferred to the preservation company and/or the insurance company, thus providing another opportunity for the generation of fees to the preservation company and/or insurance company on the annuity policy.

The present invention may be used by insurance companies or related companies which provide annuities to policy holders and is not limited to the type of company providing the policy. For example, the present invention may be used in key man insurance policies by providing an annuity for the storage and/or maintenance of biological material (such as DNA, proteins and peripheral blood cells from a mononuclear fraction of the blood, which would contain stem cells, marrow cells, etc.) which could be used in case an executive or other key employee of a company were to contract a debilitating disease. This method would provide coverage ancillary to an insurance policy such that the biological material could be used in the event the executive or other key employee were to be stricken. This would allow the insurance company to charge additional fees (annuity fee) for the maintenance of the biological material, or alternatively, may provide a basis to reduce the cost of the insurance policy to the company or individual purchasing the policy for key employees.

The present method also derives benefit from the recognition that the science of medicine and biology continues to advance, and the no pay annuity of the present invention may provide individuals with an opportunity to store biological material for the purpose of allowing future science and developments to find a therapeutic use for that material.

The present invention contemplates that when the provision of the ancillary services terminate, there is no payout by, or liability on the part of, the insurance company. Instead, there is a retrieval and delivery of the preserved and stored biological material under the auspices of the ancillary service provider. In the case of a health insurance policy having ancillary storage and preservation services, the stored material is provided at the behest of the insured or beneficiary. This requester is typically responsible for the costs of the retrieval and delivery procedures. The transfer of the preserved materials generally, but not necessarily, terminates the obligation of the insurance company (and the policy holder) to make payments to the ancillary service provider.

### BRIEF DESCRIPTION OF THE DRAWINGS

FIG. 1 is a block diagram showing a flow of money and services in a method pursuant to the present invention.

FIG. 2 is a flow chart diagram of steps in a business method in accordance with the present invention.

### DEFINITIONS

The following terms, in certain instances, shall be used in describing the present invention.

BONE MARROW—The milky-like substance found in the center of bones which produces all of the body's blood cells.

PERIPHERAL BLOOD—Blood circulating through the veins and arteries.

STEM CELL—The vital cell produced in the bone marrow of all vertebrates which is capable of reproducing itself or developing into other types of blood cells.

UMBILICAL CORD—The strand of tissue connecting the fetus to the placenta. It contains the blood vessels that supply nutrients to the fetus. During the gestation period nutrients are brought to the baby and waste materials are disposed from the fetus through the umbilical cord blood.

ANCILLARY SERVICES—Services provided by a non-insurance company to an insured person or a third-party beneficiary of an insurance policy to further the interests of the insured in taking out the insurance policy. Typically, the services are to be performed either continuously or periodically during the term of the insurance policy or a portion thereof. Exemplarily, where the insurance policy is for health insurance, the ancillary services may be the preservation and storage of biological material such as stem cells, umbilical cord blood, placental blood, DNA, peripheral blood, and bone marrow for possible future use. Alternatively, the ancillary services may be directed to the performance of preventive health measures, which are not typically covered directly by conventional health insurance.

INITIALIZATION COSTS—Charges incurred to start the providing of ancillary services. Where the ancillary services are the preservation and storage of biological materials, the initialization costs cover the collection of one or more specimens, the testing of the specimens, for instance, for viability and purity, and the processing of the specimens, for instance, by adding a cryopreservative and reducing the temperatures of the specimens pursuant to a known schedule. These initial services are performed in part by third-party service providers including hospitals and testing laboratories. The initialization costs may also include incidental expenses, for example, bookkeeping and documentation costs incurred in setting up an account.

BIOLOGICAL MATERIALS—Any organic matter useful for medical and diagnostic purposes. Organic matter tends to decompose in naturally occurring processes and thus requires special preservation to insure viability at a later time. Biological materials include stem cells, umbilical cord blood, placental blood, DNA, peripheral blood, and bone marrow but may also include tissue samples and organ parts or wholes of any useful type. Other specific kinds of biological materials which are possibly useful in carrying out the method of the present invention include corneas, vascular tissues, kidneys and kidney tissues, etc.

PRESERVATION AND/OR STORAGE COMPANY—A corporation whose business includes preserving and storing biological materials.

POLICY HOLDER—A natural or legal person who establishes a contract with an insurance policy for receiving financial services in return for one or more monetary payments to the insurance company. The financial services are typically of a contingent nature and are paid out or performed only if an event occurs as provided for in the contract. Such an event is typically an accidental loss or accidental injury to person or property.

BENEFICIARY—A person designated by a holder of an insurance policy as a recipient of benefits under the policy. A beneficiary is typically a person who is not customarily named as a secondary insured on an insurance policy and may even be someone unrelated to the policy holder.

### DETAILED DESCRIPTION OF THE PREFERRED EMBODIMENTS

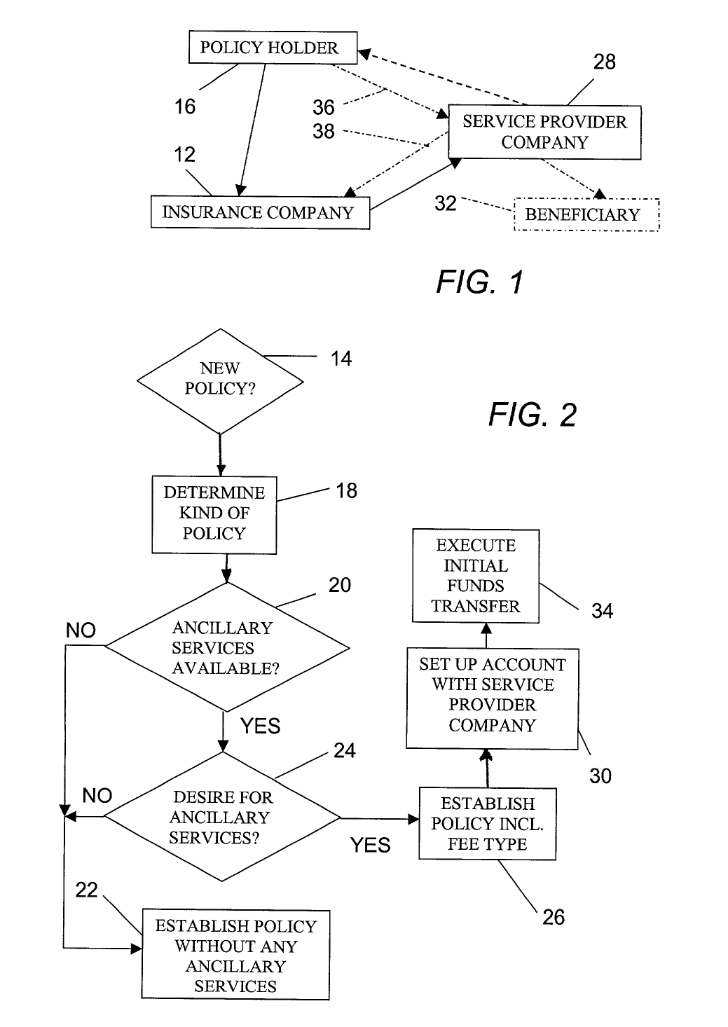

As illustrated in FIGS. 1 and 2, an insurance service provider 12 ascertains at a decision junction 14 whether a customer or potential policy holder 16 wishes to open a new insurance policy. If so, the insurance company 12 determines the kind of policy in a step 18. Possible types of policies include health insurance, home owner's insurance, automobile insurance, key man insurance, etc. The insurance company 12 investigates in an inquiry 20 whether ancillary services are available for the type of policy selected by the customer 16. In the case of a health insurance policy, ancillary services may include the preservation and storage of biological materials such as umbilical or placental blood containing stem cells. If no ancillary services are available, the company sets up a conventional policy in a step 22. If ancillary services are available, a query 24 is made as to whether the customer is interested in being provided with the ancillary services. A negative answer to query 24 results in the establishing of a conventional policy in step 22. A positive answer to query 24 leads to the establishing of a new kind of policy in a step 26.

The establishing of the new policy in step 26 includes a determination of how the ancillary services are to be funded. The ancillary services typically entail an initialization cost and a continuing preservation and storage cost. In one finding procedure, the initialization costs (collecting, testing, and processing in the case of biological materials) are paid by the insurance company 12 as part of its overhead in obtaining new policy holders and/or new policies for existing policy holders, while the continuing costs are at least partially covered by the insurance premium paid by the insured or policy holder 16. Alternatively, all or part of the initialization costs and all or part of the continuing costs may be accounted for as reductions in the cash value of the policy. In that case, where there is a cash payment to the service provider (e.g., a company which preserves and stores biological materials), the payment comes out of the cash reserves of the insurance company, which is possible since there is an associate reduction in the cash value of the applicable insurance policy.

In another step 30 of the process, the insurance company 12 communicates with the outside service provider 28 to set up an account with the service provider in the name of the policy holder 16, a secondary insured of the policy, or a third party beneficiary 32. In the case of a health insurance policy involving the preservation and storage of biological materials such as stem cells or umbilical cord blood, the biological materials may be of the primary insured 16, a secondary insured (such as progeny of the policy holder 16), or a third party 32 who is generally not routinely included in insurance policies. In the case of health or disability insurance, the third party beneficiary 32 may be (a) an expectant mother related or unrelated to the policy holder 16 or (b) a key corporate employee where the policy holder is a corporation. Other types of beneficiaries are also within the scope of the insurance methodology as contemplated herein.

The biological materials may be stem cells, umbilical cord blood, placental blood, DNA, peripheral blood, and/or bone marrow. The biological materials may belong to the policy holder (the primary insured), a secondary insured such as a child of the policy holder, or an unrelated third-party adult or child. Where the policy holder is a legal entity such as a corporation, the biological materials may belong to a key employee of the legal entity. Thus, should the key employee become ill, injured or otherwise incapacitated, the biological materials may be recalled from storage for assisting in restoring the employee to effective functioning.

Generally, the method requires an identification of the party from which the stored materials are derived. More particularly, when the policy is established in step 26, the insurance company 12 receives, from the policy holder 16, a notice identifying the beneficiary 32. In setting up the account with the service provider company 28 in step 30, insurance company 12 forwards an identification of the beneficiary 32 to the other company 28.

The insurance policy may be directed solely to the preservation and storage of these biological materials or, alternatively, these services may be ancillary to a conventional health insurance policy. In any case, there is typically an initial funds transfer 34 (FIG. 2) from insurance company 12 to services provider 28. This initial funds transfer serves to cover costs incurred in opening an account, collecting, testing, and processing biological materials, and instituting the storage process. As discussed above, funds transfer 34 may entail payment from promotional funds of the insurance company 12 which that company has accounted for as overhead in generating new business. Alternatively, funds transfer 34 may be accomplished as a transfer from a cash reserve account of the insurance company 12. In that case, funds transfer step 34 includes decrementing the cash value of the associated insurance policy. Other accounting procedures may be used which are familiar to the insurance industry. For instance, the initialization costs covered by funds transfer 34 may be debited against future premium payments by the primary insured or policy holder.

In another variation of the process described herein for financially supporting the preservation and storage of biological materials, the insurance company may be more directly involved in the initialization process. For instance, the insurance company may provide, to the policy holder, primary insured, secondary insured or third-party beneficiary, a starter kit for collecting and documenting blood taken from that person. This is particularly convenient in the case of a health insurance policy where the insurance company 12 is notified early on as to the pregnancy of an insured person. The delivery of the collection or start-up kit serves to remind the insured to have umbilical blood collected from a newborn and provides incentive for future premium payments on the insurance policy.

As described above, the insurance method may further include the collecting of a premium from policy holder 16 at regular predetermined intervals to maintain the insurance policy. The insurance company 12 may advance a portion of the premium to service company 28 to cover continuing storage and preservation costs. In the case of a third party beneficiary, the third party 32 (or parent of the third party where an infant is named) may eventually assume the payment of the premium charges, at least insofar as the continuing charges are concerned.

Where the insurance policy has a current cash value, the insurance company 12 may in effect deduct the payments to service provider company 28 from the cash value of the policy. Of course, a combination of these two methods may be used. For instance, where the premium payments terminate prior to the release of the stored biological materials by the preservation/storage company 28, regardless of whether that termination is planned as part of the policy agreement or occurs as a default on the part of the policy holder, remaining payments to the service provider company 28 could be accounted for as reductions in the cash value of the insurance policy.

Although it is contemplated that insurance company 12 will periodically pay a predetermined storage fee to service company 28 in support of storage services performed by company 28 on behalf of the policy holder 16, it is possible for an upfront payment to be made to cover storage of the materials for a predetermined period such as the expected lifetime of the protected person (primary or secondary insured or other beneficiary), or some portion of the expected lifetime.

The present method contemplates that the storage/preservation company 28 will eventually change the services it provides on behalf of the policy holder 16. Typically, this change involves a cessation of the storage service. Storage company 28 will provide notice to insurance company 12 that services performed by the storage company on behalf of the policy holder 16 have ceased or otherwise changed. Thereafter, insurance company 12 adjusts the fee paid to the storage company 28. Where the storage services have ceased, for instance, because the stored biological materials are released to be used for their intended purpose, the adjustment in fee payment involves a termination of the payments.

It is also possible for preserved biological material, particularly stem cells from a neonate, to be abandoned by the policy holder or beneficiary. For instance, the policy holder could terminate premium payments without legal recourse. Or the beneficiary may die in an accident without having had the benefit of the preserved materials. These abandoned materials may become valuable for research purposes as well as in other allogeneic procedures. Thus, the insurance policy may provide that in such circumstances, perhaps after the policy holder, the beneficiary or a relative has had an opportunity to refuse ownership of the preserved biological materials, the ownership of the biological material will be transferred to the preservation company and/or the insurance company, thus providing another opportunity for the generation of fees to the preservation company and/or insurance company on the annuity policy.

As schematically illustrated in FIG. 1, policy holder 16 (or other party) may make payments 36 directly to the service provider company 28 to cover the costs of continuing preservation and storage of biological materials. Company 28 may have an agreement with the insurance company 12, whereby the annual storage fees are split with the insurance provider 12 (as indicated at 38), partially or fully reimbursing the insurance company for covering the initial or initialization costs. Where there is a splitting or sharing of the annual fee payments made by the policy holder, a secondary insured, a beneficiary or other person, the respective percentages may vary in any way suitable to the purposes of the two companies 12 and 28.

In another modification of a business method involving the storage of biological materials derived, for instance, from umbilical cord blood, medical history data may be collected and collated pertaining to the newborn or other donor from whom the biological material is collected. The historical medical data preferentially includes the medical histories of the parents and grandparents, as well as other close relatives. To the extent that the medical histories reveal a possible predisposition of the donor of the biological materials to a particular kind of disease, a portion of the biological materials may be segregated for a use related to that disease. For example, the segregated materials, as well as pertinent medical history data, may be provided to a research institution or company that specializes in seeking a treatment for the disease. Alternatively, the segregated materials may be stored in a separate container for possible later use by a research institution or company.

Although the invention has been described in terms of particular embodiments and applications, one of ordinary skill in the art, in light of this teaching, can generate additional embodiments and modifications without departing from the spirit of or exceeding the scope of the claimed invention. Accordingly, the drawings and descriptions herein are proffered to facilitate comprehension of the invention and not to limit or circumscribe the scope thereof.

What is claimed is:

1. A business method comprising:
establishing an insurance policy for a selected policy holder;
collecting a premium to maintain said insurance policy;
establishing a current cash value for said insurance policy;
paying a service company a predetermined fee in support of services performed by said company on behalf of said policy holder; and
accounting for said fee from at least one of said premium and said current cash value.

2. The business method set forth in claim 1 wherein said services are continuing over an indefinite period of time and said fee is a periodic fee paid at least in part at discrete intervals over said period of time.

3. The business method set forth in claim 2 wherein a portion of all services provided by said service company on behalf of said policy holder, other services provided by said service company on behalf of said policy holder including initialization services, further comprising paying said service company for performance of said initialization services.

4. The business method set forth in claim 3 wherein the payment for said initialization services is from funds other than said premium and said current cash value.

5. The business method set forth in claim 4 wherein all payments of said predetermined fee total less than a cost of the continuing services.

6. The business method set forth in claim 5 wherein said insurance policy is a health insurance policy and where said continuing services are for storage and preservation of biological materials ancillary to said health insurance policy, said initialization services including collection, testing and processing services.

7. The business method set forth in claim 1 wherein said services are ancillary to protection provided by said insurance policy, said insurance policy providing protections in addition to said services.

8. The business method set forth in claim 7 wherein said insurance policy is a health insurance policy and said company stores biological materials ancillary to said health insurance policy.

9. The business method set forth in claim 8 wherein said biological materials are taken from the group consisting of stem cells, umbilical cord blood, placental blood, DNA, peripheral blood, and bone marrow.

10. The business method set forth in claim 8 wherein said biological materials belong to a member of said policy holder's family.

11. The business method set forth in claim 1 wherein said insurance policy includes a third party beneficiary named by said policy holder, said company storing biological materials belonging to a member of said beneficiary's family, including said beneficiary.

12. The business method set forth in claim 11 wherein said policy holder is a corporation and said beneficiary is an employee of said corporation.

13. The business method set forth in claim 11, further comprising:
receiving, from said policy holder, notice identifying said beneficiary; and
forwarding an identification of said beneficiary to said company.

14. The business method set forth in claim 1, further comprising:
receiving notice that services performed by said company on behalf of said policy holder have changed; and
after receiving of the notice, adjusting said fee paid to said company.

15. The business method set forth in claim 14 wherein the change in the services provided by said company include the termination of services on behalf of said policy holder, the adjusting of said fee including adjusting said fee to zero and terminating payments made to said company.

16. A business method comprising:
establishing an insurance policy for a selected policy holder;
collecting a premium at regular predetermined intervals to maintain said insurance policy;
establishing a current cash value for said insurance policy;
periodically paying a storage services company a fee in support of storage services performed by said storage services company on behalf of said policy holder;
accounting for said fee from at least one of said premium and said current cash value;
receiving notice that storage services performed by said storage services company on behalf of said policy holder have changed; and
after receiving of the notice, adjusting said fee paid to said storage services company.

17. The business method set forth in claim 16 wherein said insurance policy is a health insurance policy and said storage services company stores biological materials ancillary to said health insurance policy.

18. The business method set forth in claim 17 wherein said biological materials are taken from the group consisting of stem cells, umbilical cord blood, placental blood, DNA, peripheral blood, and bone marrow.

19. The business method set forth in claim 17 wherein said biological materials belong to a member of said policy holder's family.

20. The business method set forth in claim 16 wherein said insurance policy includes a third party beneficiary named by said policy holder, said storage services company storing biological materials belonging to a member of said beneficiary's family, including said beneficiary.

21. The business method set forth in claim 20 wherein said policy holder is a corporation and said beneficiary is an employee of said corporation.

22. The business method set forth in claim 20, further comprising:
receiving, from said policy holder, notice identifying said beneficiary; and
forwarding an identification of said beneficiary to said storage services company.

23. The business method set forth in claim 16 wherein the change in the services provided by said storage services company include the termination of storage services on behalf of said policy holder, the adjusting of said fee including adjusting said fee to zero and terminating payments made to said storage services company.

24. An insurance method comprising:
establishing an insurance policy for a selected policy holder;
establishing a current cash value for said insurance policy; and
providing to said policy holder an additional insurance benefit in return for a reduction in said current cash value.

25. The method defined in claim 24 wherein said additional insurance benefit is an ancillary insurance policy.

26. The method defined in claim 25 wherein said ancillary insurance policy is a college fund for a member of said policy holder's family.

27. An insurance method comprising:
establishing a no pay annuity for the storage and/or maintenance of biological material for a policy holder; and
collecting fees at regular, predetermined individuals, from said policy holder or other individual to maintain the annuity in effect.

28. A business method comprising:
establishing an insurance policy for a selected policy holder;
collecting a premium to maintain said insurance policy;
establishing a current cash value for said insurance policy; and
paying out, from at least one of said premium and said current cash value, funds to cover initialization costs for the preservation and storage of biological materials in connection with said insurance policy.

29. The business method set forth in claim 28, further comprising receiving reimbursement, for the paying out of said funds, from a preservation and storage company, said reimbursement being derived from at least one annual storage fee paid to the preservation and storage company.

30. The business method set forth in claim 28 wherein said biological materials are taken from the group consisting of stem cells, umbilical cord blood, placental blood, DNA, peripheral blood, and bone marrow.

31. The business method set forth in claim 28 wherein said biological materials belong to a member of said policy holder's family.

32. The business method set forth in claim 28 wherein said insurance policy includes a third party beneficiary named by said policy holder, said storage services company storing biological materials belonging to a member of said beneficiary's family, including said beneficiary.
